(19) United States
(12) Patent Application Publication
(10) Pub. No.: US 2023/0339193 A1
(43) Pub. Date: Oct. 26, 2023

(54) ULTRASONIC WELDING DEVICE AND ULTRASONIC WELDING METHOD

(71) Applicant: DELTA ELECTRONICS, INC., Taoyuan City (TW)

(72) Inventors: Jen-Chieh TSAI, Taoyuan City (TW); Chen-Wei LIU, Taoyuan City (TW); Cheng-Wei CHIU, Taoyuan City (TW); Yi-Chih HSU, Taoyuan City (TW)

(21) Appl. No.: 18/048,446

(22) Filed: Oct. 21, 2022

(30) Foreign Application Priority Data
Apr. 22, 2022 (CN) 202210429287.4

(51) Int. Cl. B29C 65/00

(52) U.S. Cl. CPC B29C 66/53461; B29C 66/12841; B29C 65/08

(57) ABSTRACT

An ultrasonic welding device includes a first component and a second component. The first component includes at least one first welding feature and at least one second welding feature which are arranged along a horizontal direction, and the first and second welding features have different sizes in a vertical direction. The second component has at least one welding structure which is configured to be in contact with the first and second welding features, so as to weld the first and second components.

### CROSS-REFERENCE TO RELATED APPLICATION

This application claims priority to China Application Serial Number 202210429287.4, filed on Apr. 22, 2022, which is herein incorporated by reference in its entirety.

### BACKGROUND

### Field of Invention

The present invention relates to a welding device and a welding method. More particularly, the present invention an ultrasonic welding device and an ultrasonic welding method.

### Description of Related Art

With the innovation and progress of science and technology, various electronic products have been constantly launched. However, electronic products are easily affected by liquids and damaged due to humidity and rust.

In the existing practice, manufacturers use a rubber ring (eg, an O-shaped rubber ring) as a waterproofing means to prevent liquid from flowing into the interior of the electronic product and blocking the gas outside the electronic product. However, the rubber ring has inherent problems such as deterioration, high material cost, and inconvenient assembly.

Therefore, how to provide a waterproof device that is both convenient and simple to manufacture and can effectively block liquids and a manufacturing method thereof has become a research target for private enterprises and academic units to invest money, manpower and time.

### SUMMARY

It is therefore an objective of the present invention to provide an ultrasonic welding device including a first component and a second component. The first component includes at least one first welding feature and at least one second welding feature, and the first welding feature and the second welding feature are arranged along a horizontal direction, the first welding feature and the second welding feature have different sizes in a vertical direction. The second component includes at least one welding structure, and the welding structure is configured to be in contact with the first welding feature and the second welding feature for welding the first component to the second component.

In some embodiments of the present invention, the at least one first welding feature includes a plurality of first welding features, and the at least one second welding feature includes a plurality of second welding features. The first welding features and the second welding features are alternately arranged.

In some embodiments of the present invention, each first welding feature is in contact with adjacent two of the second welding features.

In some embodiments of the present invention, the first welding features and the second welding features surround a center axis of the first component.

In some embodiments of the present invention, the first welding features and the second welding features surround a center axis of the first component, and the first welding features and the second welding features are in a central symmetry relative to the center axis.

In some embodiments of the present invention, a ratio of a horizontal width of the first welding feature to a horizontal width of the second welding feature ranges from 1.5 to 3.

In some embodiments of the present invention, a ratio of a vertical length of the first welding feature to a vertical length of the second welding feature ranges from 1.2 to 6.

In some embodiments of the present invention, the welding structure includes a stepped inner wall.

Another aspect of the present invention relates to an ultrasonic welding method which includes providing a welding device including a first component and a second component. The first component includes at least one first welding feature and at least one second welding feature, and the first welding feature and the second welding feature are arranged along a horizontal direction, the first welding feature and the second welding feature have different sizes in a vertical direction. The second component includes at least one welding structure, and the welding structure is configured to be in contact with the first welding feature and the second welding feature for welding the first component to the second component. The ultrasonic welding method further includes pressing the first component to the second component such that the welding structure is in contact with the first welding feature and the second welding feature and joining the first component and the second component by welding the welding structure, the first welding feature, and the second welding feature.

In some embodiments of the present invention, the at least one first welding feature includes a plurality of first welding features, and the at least one second welding feature includes a plurality of second welding features. The first welding features and the second welding features are alternately arranged.

In some embodiments of the present invention, each first welding feature is in contact with adjacent two of the second welding features.

In some embodiments of the present invention, the first welding features and the second welding features surround a center axis of the first component.

In some embodiments of the present invention, the first welding features and the second welding features surround a center axis of the first component, and the first welding features and the second welding features are in a central symmetry relative to the center axis.

In some embodiments of the present invention, a ratio of a horizontal width of the first welding feature to a horizontal width of the second welding feature ranges from 1.5 to 3.

In some embodiments of the present invention, a ratio of a vertical length of the first welding feature to a vertical length of the second welding feature ranges from 1.2 to 6.

In some embodiments of the present invention, the welding structure includes a stepped inner wall.

To sum up, an ultrasonic welding device and an ultrasonic welding method are provided in the present invention, and the ultrasonic welding device includes a first component and a second component for mutual welding. The first component includes a first welding feature and a second welding feature which have different sizes in a vertical direction. The second component includes a welding structure configured to be in contact with the first welding feature and the second welding feature. As such, the ultrasonic welding device can control the melting directions of the first welding feature and the second welding feature in an ultrasonic welding process, and the ultrasonic welding device has an outstanding mechanical strength and a supporting ability.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 illustrates a schematic view of an ultrasonic welding device in accordance with some embodiments of the present invention.

FIG. 2 illustrates a flow chart of an ultrasonic welding method in accordance with some embodiments of the present invention.

FIG. 3 illustrates a schematic view of a first component in accordance with some embodiments of the present invention.

FIG. 4 illustrates a schematic view of a second component in accordance with some embodiments of the present invention.

FIG. 5 illustrates a schematic view of an ultrasonic welding device in accordance with some embodiments of the present invention, and the second component is shown in dotted lines and in perspective.

FIG. 6 illustrates an enlarged view according to the doted square D in FIG. 5.

FIG. 7 illustrates a cross section view according to the cross section line A-A in FIG. 5.

FIG. 8 illustrates a cross section view according to the cross section line B-B in FIG. 5.

FIG. 9 illustrates a schematic view of an ultrasonic welding device in accordance with some embodiments of the present invention, and the second component is shown in dotted lines and in perspective.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

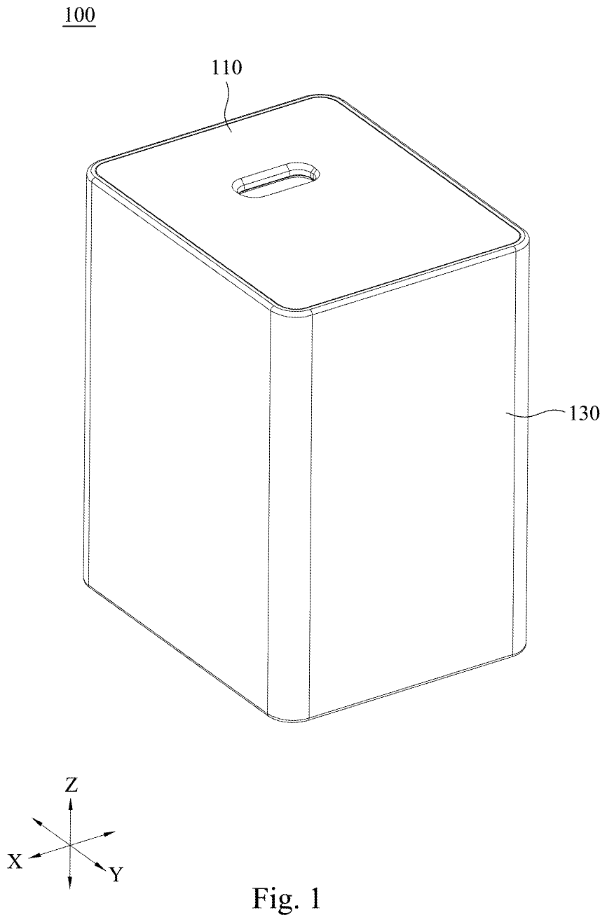

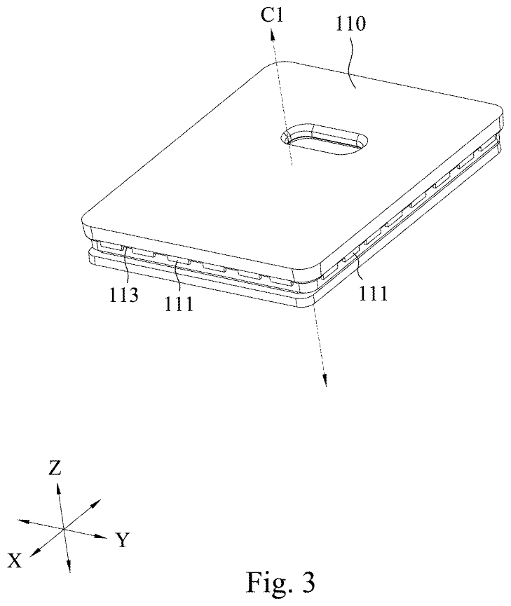

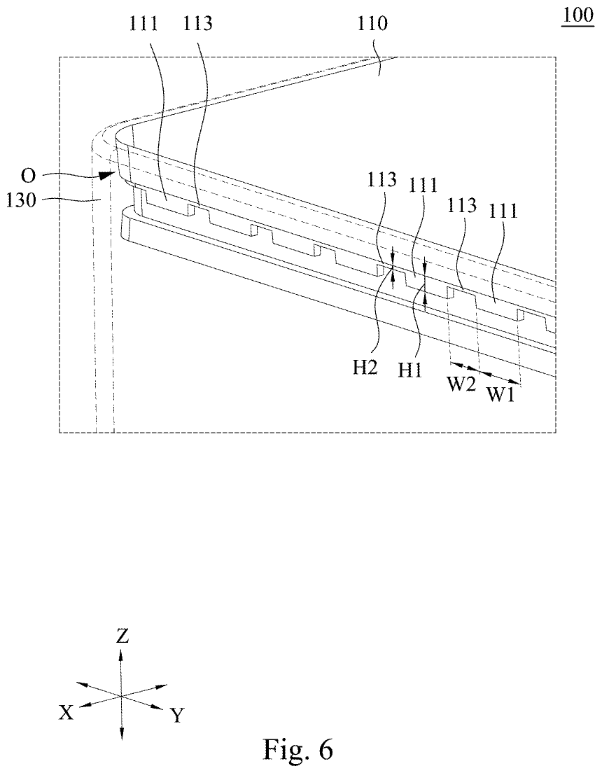

Reference is made to FIG. 1, and FIGS. 3-6. In some embodiments of the present invention, an ultrasonic welding device 100 includes a first component 110 and a second component 130. The first component 110 includes at least one first welding feature 111 and at least one second welding feature 113, in which the first welding feature 111 and the second welding feature 113 are arranged along a horizontal direction such as first horizontal axial direction X and second horizontal axial direction Y, and the first welding feature 111 and the second welding feature 113 have different sizes in a vertical direction such as vertical axial direction Z. For instance, a size of the first welding feature 111 is greater than a size of the second welding feature 113. The second component 130 has at least one welding structure 131, and the welding structure 131 is configured to be in contact with the first welding feature 111 and the second welding feature 113 such that the first component 110 is welded to the second component 130. In addition, the first horizontal axial direction X is perpendicular to the second horizontal axial direction Y, and the vertical axial direction Z is perpendicular to the first horizontal axial direction X and the second horizontal axial direction Y. The first welding feature 111 and the second welding feature 113 can provide an outstanding waterproof ability between the first component 110 and the second component after being welded, and the first welding feature 111 which has a greater size in the vertical axial direction Z than the second welding feature 113 can improve the mechanical strength of the first component 110 and the second component 130 after the welding process.

Specifically, the first component 110 is pressed to the second component 130, and materials of the first component 110 and the second component 130 can be melted together via energy generated from ultrasonic vibrations. Thereafter, the first component 110 and/or the second component 130 are cooled such that the first component 110 stably joins the second component 130. For instance, shock waves with high frequency from 15 kHz to 20 kHz are generated by a wave generator, and a driving head fixed to the wave generator which is in contact with the first component 110 causes friction and high temperature such that the materials of the first component 110 and the second component 130 are melted and mutually joined. The present invention is not limited in this respect. In some embodiments of the present invention, the first component 110 and the second component 130 can be made of thermoplastic materials such as polystyrene, polycarbonate, and polysulfide compound, and the present invention is not limited in this respect.

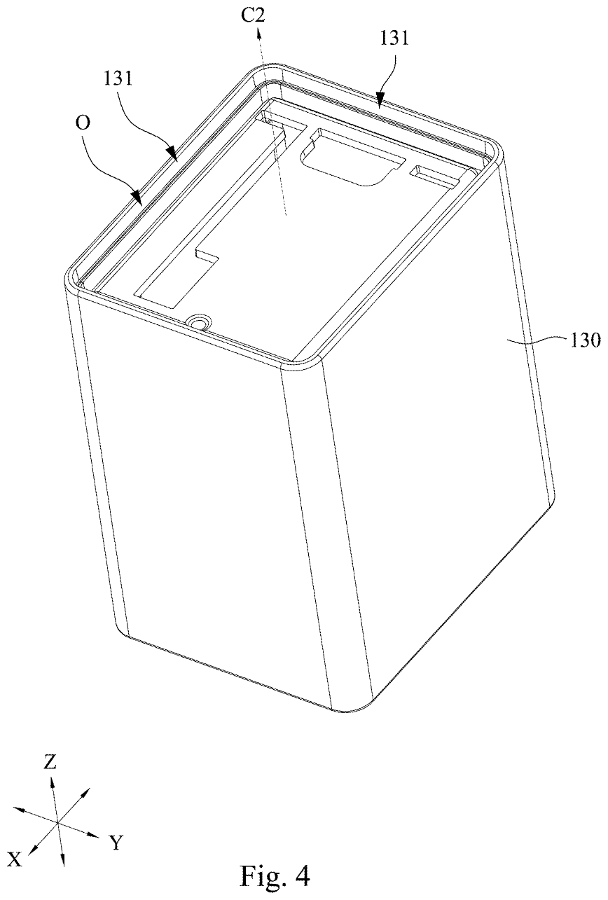

In addition, the first component 110 is a lid, and the second component 130 is a box in a shape corresponding to the first component 110. For instance, the first component 110 is in a circle shape, a triangle shape, a rectangle shape, a square shape, or a polygon shape when the first component 110 is viewed from above. For instance, the second component 130 can have a recess which is in a circle shape, a triangle shape, a rectangle shape, a square shape, or a polygon shape. Referring to FIGS. 3-4, a user can align a center axis C1 of the first component 110 with a center axis C2 of the second component 130 and then cover the second component 130 with the first component 110. When the first component 110 covers the second component 130, a plurality of the first welding features 111 and a plurality of the second welding features 113 are respectively in contact with a plurality of welding surfaces of the second component 130. In addition, the second component 130 can limit the first component 110 in a horizontal direction such as the first horizontal axial direction X and the second horizontal axial direction Y, and a user can only move the first component 110 away from the second component 130 along the vertical axial direction Z, so as to prevent the first component 110 from dropping out of the second component 130 due to shake and external force.

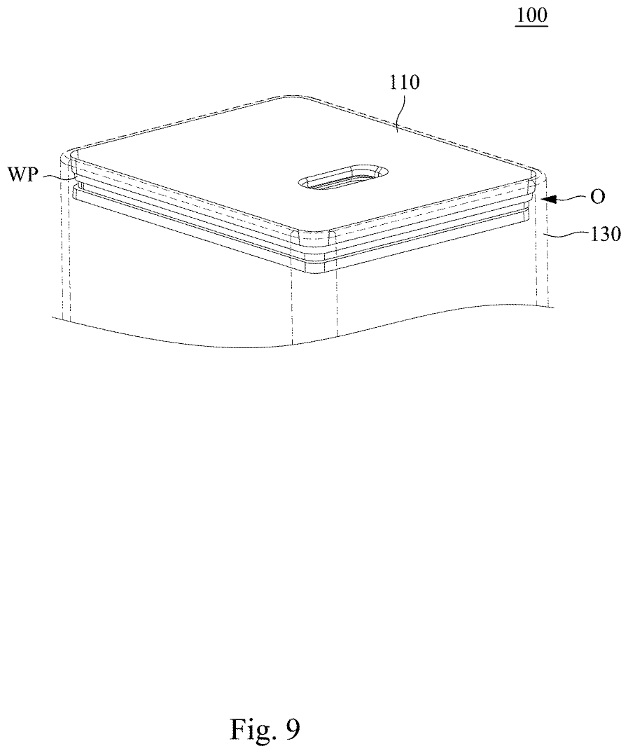

In some embodiments of the present invention, the first component 110 includes a plurality of the first welding features 111 and a plurality of the second welding feature 113, and the first welding features 111 and the second welding features 113 are disposed at a periphery of the first component 110 to surround the center axis C1 of the first component 110. The first welding features 111 and the second welding features 113 are continuously and alternately arranged to be in a central symmetry relative to the center axis C1, and each first welding feature 111 is in contact with adjacent two of the second welding features 113. Moreover, the welding structures 131 are welding surfaces which face and surround the center axis C2 of the second component 130, and the welding surfaces are parallel to or inclined to the center axis C2 of the second component 130. The welding surfaces are in a central symmetry relative to the center axis C2. As such, after the first component 110 and the second component 130 are welded, a complete and ring-shaped waterproof structure WP (referring to FIG. 9) is formed to provide an outstanding waterproof ability and improve the mechanical strength of the first component 110 and the second component 130.

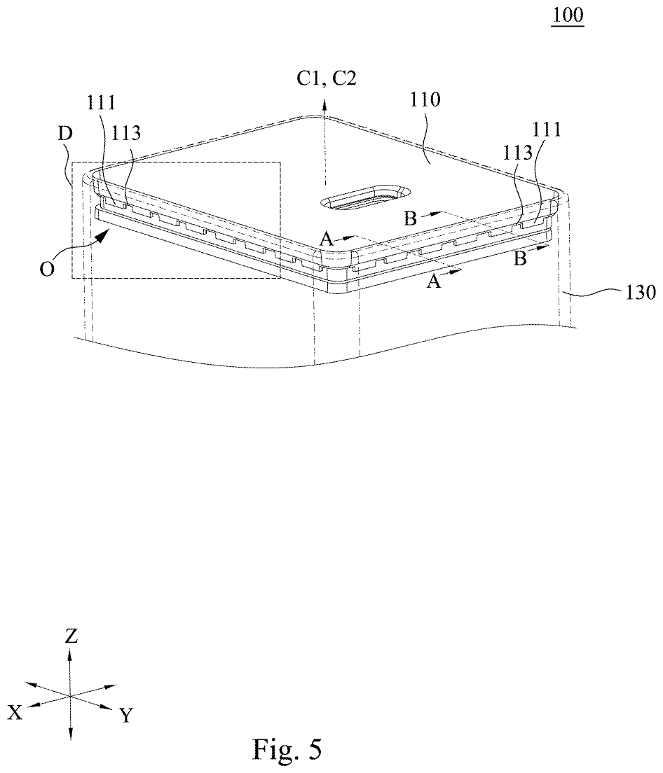

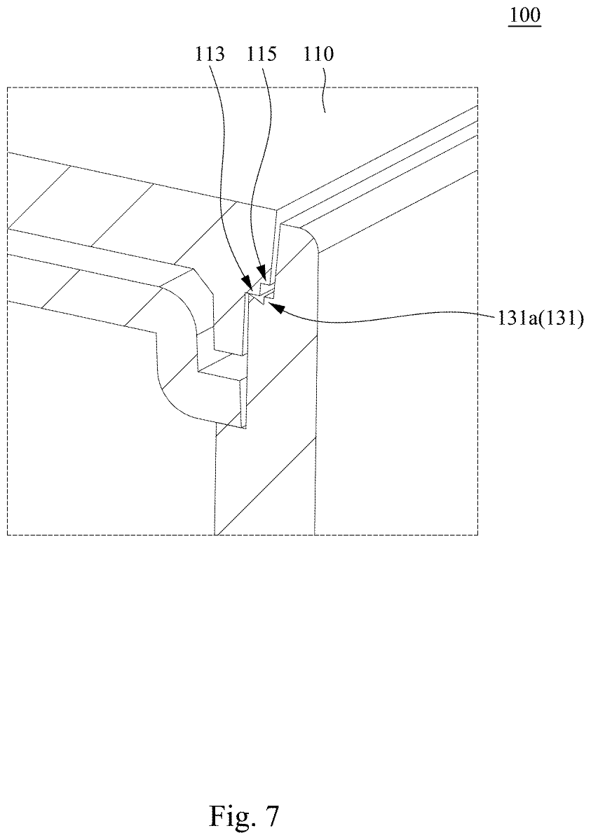

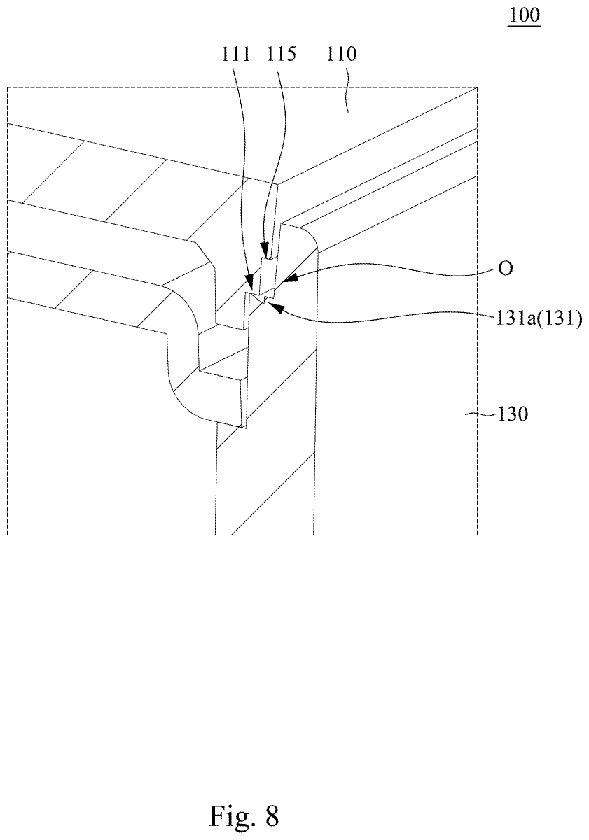

Reference is made to FIG. 7 and FIG. 8. The first component 110 includes an align portion 115, and the align portion 115 is located above the first welding features 111 and the second welding features 113. The welding structure 131 includes a stepped inner wall 131a, and the align portion 115 is configured to be in contact with the stepped inner wall 131a and form accommodation spaces having different sizes in the vertical axial direction Z with the stepped inner wall 131a (referring to FIGS. 5, 7, and 10). Specifically, the align portion 115 and the stepped inner wall 131a have continuous corrugated structures, and the align portion 115 is located at a periphery of the first component 110 to surround the center axis C1 of the first component 110. The stepped inner wall 131a is disposed at an opening O of the second component 130, and the stepped inner wall 131a surrounds the center axis C2 of the second component 130 such that the align portion 115 and the stepped inner wall 131a are mutually aligned to form accommodation spaces used in the ultrasonic welding process when the first component 110 covers the second component 130. In addition, the align portion 115 and the stepped inner wall 131a can have a continuous spiky corrugated structure or a continuous curved corrugated structure, and the present invention is not disclosed in this respect. When the align portion 115 and the stepped inner wall 131a have the continuous corrugated structures with a small contact, the first component 110 can be efficiently heated and welded to the second component 130.

In some embodiments of the present invention, the first welding feature 111 and the second welding feature 113 are strips such as rectangular strips, and the first welding feature 111 has a horizontal width W1 ranges from 1.5 millimeters (mm) to 6 mm. In other embodiments, the horizontal width W1 ranges from 2.5 mm to 4.5 mm. In other embodiments, the horizontal width W1 ranges from 3 mm to 3.5 mm. In some embodiments of the present invention, the horizontal width W2 of the second welding feature 113 ranges from 0.5 mm to 3 mm. In other embodiments, the horizontal width W2 of the second welding feature 113 ranges from 0.5 mm to 2.5 mm. In other embodiments, the horizontal width W2 of the second welding feature 113 ranges from 1 mm to 2 mm. In other embodiments, the horizontal width W2 of the second welding feature 113 ranges from 1.5 mm to 1.75 mm. By the horizontal width W1 of the first welding feature 111 and the horizontal width W2 of the second welding feature 113, the first welding feature 111 and the second welding feature 113 can be in close contact with the welding structure 131 and welded to form the waterproof structure WP (referring to FIG. 9), so as to provide an outstanding waterproof ability.

In some embodiments of the present invention, a ratio of the horizontal width W1 of the first welding feature 111 to the horizontal width W2 of the second welding feature 113 ranges from 1.5 to 3. In other embodiments, a ratio of the horizontal width W1 of the first welding feature 111 to the horizontal width W2 of the second welding feature 113 ranges from 1.75 to 2.75. In other embodiments, a ratio of the horizontal width W1 of the first welding feature 111 to the horizontal width W2 of the second welding feature 113 ranges from 1.75 to 2.5. By the ratio of the horizontal width W1 of the first welding feature 111 to the horizontal width W2 of the second welding feature 113, the first welding feature 111 and the second welding feature 113 can be in closely contact with the welding structure 131 and welded to form the waterproof structure WP (referring to), so as to provide an outstanding waterproof ability. In addition, the above ratio of the horizontal width W1 to the horizontal width W2 is benefit for strongly supporting the first component 110 and the second component 130, so as to improve the entire mechanical strength thereof.

In some embodiments of the present invention, the vertical length H1 of the first welding feature 111 ranges from 0.3 mm to 2 mm. In other embodiments, the vertical length H1 of the first welding feature 111 ranges from 0.4 mm to 1.5 mm. In other embodiments, the vertical length H1 of the first welding feature 111 ranges from 0.5 mm to 1.2 mm. In some embodiments of the present invention, the vertical length H2 of the second welding feature 113 ranges from 0.1 mm to 1 mm. In other embodiments, the vertical length H2 of the second welding feature 113 ranges from 0.1 mm to 0.6 mm. In other embodiments, the vertical length H2 of the second welding feature 113 ranges from 0.2 mm to 0.5 mm. By the vertical length H1 of the first welding feature 111 and the vertical length H2 of the second welding feature 113, the melting directions of the first welding feature 111 and the second welding feature 113 in the ultrasonic process can be well controlled, so as to sophisticatedly form the waterproof structure WP (referring to FIG. 9) and provide an outstanding waterproof ability.

In some embodiments of the present invention, a ratio of a vertical length H1 of the first welding feature 111 to a vertical length H2 of the second welding feature 113 ranges from 1.2 to 6. In other embodiments, a ratio of the vertical length H1 of the first welding feature 111 to the vertical length H2 of the second welding feature 113 ranges from 2.5 to 6. In other embodiments, a ratio of the vertical length H1 of the first welding feature 111 to the vertical length H2 of the second welding feature 113 ranges from 4.5 to 6. According to the ratio of the vertical length H1 of the first welding feature 111 to the vertical length H2 of the second welding feature 113, the melting directions of the first welding feature 111 and the second welding feature 113 in the ultrasonic process can be well controlled, so as to sophisticatedly form the waterproof structure WP (referring to FIG. 9) and provide an outstanding waterproof ability.

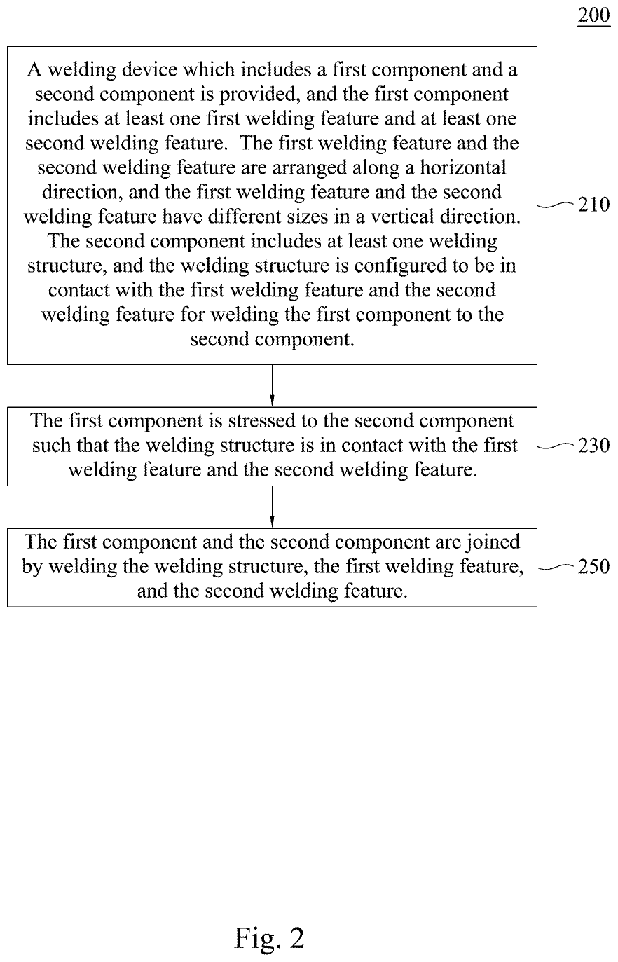

The following paragraphs introduce an ultrasonic welding method 200 using the ultrasonic welding device 100. Please refer to FIGS. 1-6. The ultrasonic welding method 200 starts from a step 210, and the step 210 includes providing the ultrasonic welding device 100. The ultrasonic welding device 100 includes the first component 110 and the second component 130, in which the first component 110 has a plurality of the first welding features 111 and a plurality of the second welding features 113. The first welding feature 111 and the second welding features 113 are arranged along a horizontal direction such as the first horizontal axial direction X and the second horizontal axial direction Y, and the first welding feature 111 and the second welding feature 113 have different sizes in the vertical axial direction Z, the second component 130 has a plurality of the welding structures 131. Thereafter, the ultrasonic welding method 200 continues with a step 230, and the step 230 includes pressing the first component 110 to the second component 130 such that the welding structures 131 are respectively in contact with the first welding features 111 and the second welding features 113. Next, the ultrasonic welding method 200 continues with a step 250, the step 250 includes welding the first component 110 to the second component 130 via a plurality of the welding structures 131, a plurality of the first welding features 111, and a plurality of the second welding features 113, so as to from the waterproof structure WP which surrounds the second component 130 (referring to FIG. 9).

In some embodiments of the present invention, the step 210 includes providing the ultrasonic welding device 100, and the first component 110 of the ultrasonic welding device 100 is a lid, the second component 130 is a box in a shape corresponding to the first component 110. For instance, when the first component 110 is viewed from above, the first component 110 is in a circle shape, a triangle shape, a rectangle shape, a square shape, or a polygon shape from. For instance, the second component 130 can have a recess which is in a circle shape, a triangle shape, a rectangle shape, a square shape, or a polygon shape. The first component 110 and the second component 130 can be made of thermoplastic material such as polystyrene, polycarbonate, and polysulfide compound, and the present invention is not limited in this respect. Detail information regarding the ultrasonic welding device 100 has been introduced in the previous paragraphs, so the detail information is not repeated.

In some embodiments of the present invention, the step 230 includes pressing the first component 110 to the second component 130 such that the welding structure 131 is in contact with the first welding feature 111 and the second welding feature 113. When the first component 110 covers the second component 130, a plurality of the first welding features 111 and a plurality of the second welding features 113 are respectively in contact with the welding surfaces. In addition, the second component 130 can limit the first component 110 in a horizontal direction such as the first horizontal axial direction X and the second horizontal axial direction Y, and a user can only move the first component 110 away from of the second component 130 along the vertical axial direction Z, so as to prevent the first component 110 from dropping out of the second component 130 due to shake and external force. Detail information regarding the first component 110 and the second component 130 is introduced in the previous paragraphs, and the detail information is not repeated.

Reference is made to FIGS. 7-8. In some embodiments of the present invention, the first component 110 includes the align portion 115, and the align portion 115 is located above the first welding feature 111 and the second welding feature 113. The welding structure 131 of the second component 130 includes a stepped inner wall 131a. The align portion 115 and the stepped inner wall 131a are mutually aligned to form accommodation spaces used in the ultrasonic welding process when the first component 110 covers the second component 130 Detail information regarding contacting and aligning the first component 110 with the second component 130 is introduced in the previous paragraphs, and the detail information is not repeated.

The step 250 includes joining the first component 110 and the second component 130 by welding the welding structure 131, the first welding feature 111, and the second welding feature 113. A user can press the first component 110 to the second component 130 and melt the first component 110 and/or the second component 130 via energy generated from ultrasonic vibration, and then the first component 110 and/or the second component 130 is cooled such that the first component 110 and the second component 130 is in close contact. For instance, shock waves with high frequency from 15 kHz to 20 kHz are generated by a wave generator, and a driving head fixed to the wave generator which is in direct contact with the first component 110 to cause friction and high temperature such that the material of the first component 110 and/or the second component 130 are melted and mutually joined. The present invention is not limited in this respect. Detail information regarding welding the first component 110 to the second component 130 is introduced in the previous paragraphs, and the detail information is not repeated.

To sum up, an ultrasonic welding device and an ultrasonic welding method are provided in the present invention, and the ultrasonic welding device includes a first component and a second component for mutual welding. The first component includes a first welding feature and a second welding feature which have different sizes in a vertical direction. The second component includes a welding structure configured to be in contact with the first welding feature and the second welding feature. As such, the ultrasonic welding device can control the melting directions of the first welding feature and the second welding feature in an ultrasonic welding process, and the ultrasonic welding device has an outstanding mechanical strength and a supporting ability.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An ultrasonic welding device, comprising:
a first component comprising at least one first welding feature and at least one second welding feature, wherein the first welding feature and the second welding feature are arranged along a horizontal direction, and the first welding feature and the second welding feature have different sizes in a vertical direction; and
a second component comprising at least one welding structure, wherein the welding structure is configured to be in contact with the first welding feature and the second welding feature for welding the first component to the second component.

2. The ultrasonic welding device of claim 1, wherein the at least one first welding feature includes a plurality of first welding features, the at least one second welding feature includes a plurality of second welding features, and wherein the first welding features and the second welding features are alternately arranged.

3. The ultrasonic welding device of claim 2, wherein each first welding feature is in contact with adjacent two of the second welding features.

4. The ultrasonic welding device of claim 2, wherein the first welding features and the second welding features surround a center axis of the first component.

5. The ultrasonic welding device of claim 2, wherein the first welding features and the second welding features surround a center axis of the first component, the first welding features and the second welding features are in a central symmetry relative to the center axis.

6. The ultrasonic welding device of claim 1, wherein a ratio of a horizontal width of the first welding feature to a horizontal width of the second welding feature ranges from 1.5 to 3.

7. The ultrasonic welding device of claim 1, wherein a ratio of a vertical length of the first welding feature to a vertical length of the second welding feature ranges from 1.2 to 6.

8. The ultrasonic welding device of claim 1, wherein the welding structure includes a stepped inner wall.

9. An ultrasonic welding method, comprising:
providing a welding device comprising:
a first component comprising at least one first welding feature and at least one second welding feature, wherein the first welding feature and the second welding feature are arranged along a horizontal direction, and the first welding feature and the second welding feature have different sizes in a vertical direction; and
a second component comprising at least one welding structure, wherein the welding structure is configured to be in contact with the first welding feature and the second welding feature for welding the first component to the second component;
pressing the first component to the second component such that the welding structure is in contact with the first welding feature and the second welding feature; and
joining the first component and the second component by welding the welding structure, the first welding feature, and the second welding feature.

10. The ultrasonic welding method of claim 9, wherein the at least one first welding feature includes a plurality of first welding features, the at least one second welding feature includes a plurality of second welding features, and wherein the first welding features and the second welding features are alternately arranged.

11. The ultrasonic welding method of claim 10, wherein each first welding feature is in contact with adjacent two of the second welding features.

12. The ultrasonic welding method of claim 10, wherein the first welding features and the second welding features surround a center axis of the first component.

13. The ultrasonic welding method of claim 10, wherein the first welding features and the second welding features surround a center axis of the first component, the first welding features and the second welding features are in a central symmetry relative to the center axis.

14. The ultrasonic welding method of claim 9, wherein a ratio of a horizontal width of the first welding feature to a horizontal width of the second welding feature ranges from 1.5 to 3.

15. The ultrasonic welding method of claim 9, wherein a ratio of a vertical length of the first welding feature to a vertical length of the second welding feature ranges from 1.2 to 6.

16. The ultrasonic welding method of claim 9, wherein the welding structure includes a stepped inner wall.
